(19) United States
(12) Patent Application Publication
(10) Pub. No.: US 2002/0143858 A1
(43) Pub. Date: Oct. 3, 2002

(54) Report scheduler

(76) Inventors: William Teague, Vienna, VA (US); Michael Perry, Bethesda, MD (US)

Correspondence Address: DENIS G. MALONEY, Fish & Richardson P.C., 225 Franklin Street, Boston, MA, 02110-2804, US

(21) Appl. No.: 09/821,599

(22) Filed: Mar. 29, 2001

(51) Int. Cl. G06F 9/00; G06F 15/16

(52) U.S. Cl. 709/203; 709/217

(57) ABSTRACT

A process, residing on a server, for scheduling the generation of reports, for retrieval via a distributed computing network by a desktop application program residing on a remote desktop computer is described. This process can allow retrieval of the reports over a distributed computing network. The process includes a data services process that maintains at least one report batch file, where each report batch file is scheduled by a user to be executed at a specific time and contains a list of reports to be generated when the report batch file is executed.

### RELATED APPLICATIONS

This application herein incorporates by reference U.S. patent application Ser. No. 09/191,655, filed on Nov. 13, 1998, entitled “Report Generation Architecture for Remotely Generated Data”.

### TECHNICAL FIELD

This invention relates to report generation, and more particularly to automated, scheduled report generation over a distributed computing network.

### BACKGROUND

The Internet, and in particular the World Wide Web, allows for the rapid dissemination of information to subscribers of various services. This information is typically available in various formats, including reports, wherein the subscriber instructs the service to generate specific reports in accordance with their needs and personal tastes. Some services allow the subscriber to arrange these various reports into groups and download these groups of reports from a remote computer to a local computer via some form of distributed computing network, typically the Internet.

The downloading of these reports typically requires interaction by the subscriber, where the subscriber has to initiate the download process. As a result of this user interaction, the downloading of these reports typically occurs during normal business hours when Internet traffic and server loading are high.

### SUMMARY

According to an aspect of this invention, a process, residing on a server, for scheduling the generation of reports, for retrieval via a distributed computing network by a desktop application program residing on a remote desktop computer includes a data services process that maintains at least one report batch file, where each report batch file is scheduled by a user to be executed at a specific time and contains a list of reports to be generated when the report batch file is executed. A batch file schedule process examines the specific time of each report batch file and selects those report batch files that need to be executed. A report parsing process, responsive to the batch file schedule process selecting report batch files for execution, analyzes the list of reports of each selected report batch file to determine the individual reports required for its respective batch file and generates a report master list which includes all the individual reports to be generated for all the selected report batch files. A report generation process, responsive to the report parsing process generating the report master list, generates the individual reports listed on the report master list from data retrieved from the data services process, where the individual reports are available for retrieval by the user.

One or more of the following features may also be included. A report posting process may post the individual reports generated by the report generation process to a server on the distributed computing network so that the reports can be downloaded by the user via a remote desktop computer. A report transmission process, responsive to the report generation process generating the individual reports, may transmit to the user via an electronic mail delivery mechanism the individual reports listed in the respective user's report batch file. A master delay process may delay the generation of all the individual reports listed on the report master list until after a specific time to minimize server loading. The report parsing process may include a report generation delay process that delays the generation of a specific individual report listed on the report master list until after the occurrence of a reconciliation event when the specific individual report needs information that will not be available until after the occurrence of the reconciliation event.

One or more of the following features may also be included. A data retrieval process may retrieve time sensitive data from the data services process prior to the occurrence of a replication event when a specific individual report needs information that will be unavailable after the occurrence of the replication event, where the time sensitive data is made available to the report generation process when the specific individual report is generated. The batch file schedule process may include a batch file filtering process that examines the content of each report batch file to determine if its list of reports specifies at least one individual report for generation by the report generation process, where the batch file schedule process prevents the execution of those report batch files that do not specify at least one individual report for generation. A report status process, responsive to the report parsing process generating the report master list, may associate a status indicator with each individual report listed on the master list which indicates the status of the generation of that specific individual report. A user interface process may allow the user to manage their report batch file by modifying the list of reports and scheduling the specific time for executing the report batch file.

According to a further aspect of this invention, a process residing on a server for scheduling the generation of reports, for retrieval via a distributed computing network by a desktop application program residing on a remote desktop computer, includes a data services process that maintains at least one report batch file, where each report batch file is scheduled by a user to be executed at a specific time and contains a list of reports to be generated when the report batch file is executed. A batch file schedule process examines the specific time of each report batch file and selects those report batch files that need to be executed. A report parsing process, responsive to the batch file schedule process selecting report batch files for execution, analyzes the list of reports of each selected report batch file to determine the individual reports required for its respective batch file and generates a report master list which includes all the individual reports to be generated for all the selected report batch files.

A report generation process, responsive to the report parsing process generating the report master list, generates the individual reports listed on the report master list from data retrieved from the data services process. A report transmission process, responsive to the report generation process generating the individual reports, transmits to the user via an electronic mail delivery mechanism the individual reports listed in the user's report batch file.

One or more of the following features may also be included. A report posting process may post the individual reports generated by the report generation process to a server on the distributed computing network so that the reports can be downloaded by the user via a remote desktop computer.

According to a further aspect of this invention, a computer program product residing on a computer readable medium having a plurality of instructions stored thereon which, when executed by the processor, cause that processor to maintain at least one report batch file, where each report batch file is scheduled by a user to be executed at a specific time and contains a list of reports to be generated when the report batch file is executed. The processor examines the specific time of each report batch file and selects those report batch files that need to be executed. The processor analyzes the list of reports of each selected report batch file to determine the individual reports required for its respective batch file and generates a report master list which includes all the individual reports to be generated for all the selected report batch files. The processor generates the individual reports listed on the report master list from data retrieved from the data services process.

One or more of the following features may also be included. The computer program product may include instructions for causing the processor to transmit to the user via an electronic mail delivery mechanism the individual reports listed in the user's report batch file. The computer program product may include instructions for causing the processor to post the individual reports listed in the user's report batch file to a server on the distributed computing network so that individual reports can be downloaded by the user via a remote desktop computer. The computer program product may include instructions for causing the processor to delay the generation of all the individual reports listed on the report master list until after a specific time to minimize server loading. The computer program product may include instructions for causing the processor to retrieve time sensitive data prior to the occurrence of a replication event when a specific individual report needs information that will be unavailable after the occurrence of the replication event, where the time sensitive data is made available when the specific individual report is generated. The computer program product may include instructions for causing the processor to examine the content of each report batch file to determine if its list of reports specifies at least one individual report for generation and prevent the execution of those report batch files that do not specify at least one individual report for generation. The computer program product may include instructions for causing the processor to allow the user to manage their report batch file by modifying the list of reports and scheduling the specific time for executing the report batch file. According to a further aspect of this invention, a method of scheduling the generation of reports includes maintaining at least one report batch file, where each report batch file is scheduled by a user to be executed at a specific time and contains a list of reports to be generated when the report batch file is executed. The method includes examining the specific time of each report batch file and selecting those report batch files that need to be executed. The method includes analyzing the list of reports of each selected report batch file to determine the individual reports required for its respective batch file and generating a report master list which includes all the individual reports to be generated for all the selected report batch files. The method includes generating the individual reports listed on the report master list from data retrieved from the data services process.

One or more of the following features may also be included. The method may include transmitting to the user via an electronic mail delivery mechanism the individual reports listed in the user's report batch file.

One or more advantages can be provided from the above. The user may have commonly used reports and groups of reports automatically generated. The user may have these reports, once generated, stored remotely on a network-based server for later retrieval by the user. The user may have these reports, once generated, automatically transmitted to the user as an electronic mail message attachment. Since these reports are scheduled, the time at which these reports are processed and generated may be controlled by the service provider. As the service provider can choose the processing and generation time, a time may be chosen which minimizes server loading.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a diagrammatic view of the report scheduler process;

FIG. 2. is a diagrammatic view of another embodiment of the report scheduler process, including a processor and a computer readable medium, and a flow chart showing a sequence of executed steps; and

FIG. 3 is a flow chart of the report scheduler method of FIG. 1.

### DETAILED DESCRIPTION

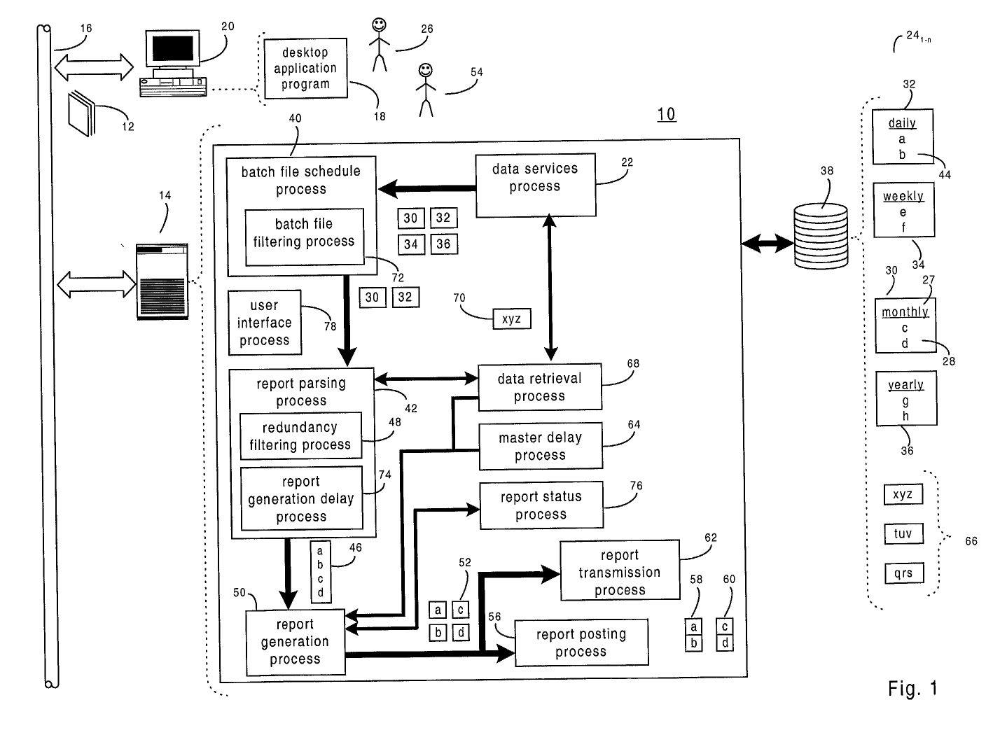

Referring to FIG. 1, there is shown a process 10 for scheduling the generation of reports 12. Process 10 resides on server 14 and is connected to a distributed computing network 16. Distributed computing network 16 could be the Internet, an intranet, a local area network or any other form of network environment. Process 10 is accessed via a desktop application program 18 running on a remote desktop computer 20, which is also connected to network 16.

Process 10 includes a data services process 22 that maintains at least one report batch file 24₁₋ₙ, where each report batch file is scheduled by user 26 to be executed at a specific time 27. Each report batch file 24₁₋ₙ, also contains a list of reports 28 to be generated when the report batch file is executed. Typically these report batch files 24₁₋ₙ are referred to as “folios” and an example of process 10 is the Folio Scheduling Service of the Nasdaq Online® system, where user 26 subscribes to process 10. As an example, for illustrative purposes only, a specific report batch file 30, which is a member of the group of report batch files 24₁₋ₙ, is scheduled by user 26 to be run monthly, as indicated by specific time 27, and contains a list of reports 28, which specifies that two reports, namely reports C & D, are to be generated when report batch file 30 is executed (on a monthly basis). The remaining reports included in the group of report batch files 24₁₋ₙ are report batch files 32, 34 and 36. While the group of report batch files 24₁₋ₙ is shown to include only four specific report batch files, this is for illustrative purposes only, as the group of report batch files 24₁₋ₙ may be as large (or as small) as needed.

Data services process 22 communicates with data repository 38 that stores report batch files 24₁₋ₙ. Data repository 38 is typically a database, such Oracle™ or Sybase™, and data services process 22 would typically use an SQL (structured query language) server (not shown) to maintain report batch files 24₁₋ₙ on data repository 38.

Batch file schedule process 40 examines the specific time 27 that each report batch file (24₁₋ₙ generally and 30, 32, 34 and 36 specifically) and selects those reports that need to be executed. Specifically, there are several different times (or periodicities) in which user 26 can schedule report batch file 30 to be executed. For example, user 26 can schedule report batch file 30 to be executed: daily; weekly (where user 26 can select the day of the week); monthly; quarterly (where user 26 can select the last month of the quarter); or annually (where user 26 can select the last month of the annual period). Therefore, if it is Friday, the 1^{st} of January, all daily report batch files would be run, weekly report batch files in which the user selected Friday would be run, all monthly report batch files would be run, quarterly report batch files in which the user selected a quarter ending after December would be run, and annual report batch files in which the user selected a year end of December would be run. Again, assuming the date is Friday, the 1^{st} of January, batch file schedule process 40 would select batch file reports 30 (the monthly report batch file) and 32 (the daily report batch file). Let's assume, for this example, that weekly report batch file 34 selects a day other than Friday and yearly report batch file 36 selects a month other than December. Accordingly, these two report batch files 34 and 36 are not executed.

A report parsing process 42 is responsive to batch file schedule process 40 selecting report batch files for execution. As stated above, batch file schedule process 40 selects report batch files 30 and 32 for execution and provides these selected report batch files to report parsing process 42. Report parsing process 42 analyzes the list of reports (28 for report batch file 30 and 44 for report batch file 32) for each of the selected report batch files 30 and 32 to determine the individual reports included in its respective report batch file. In this particular example, report batch file 30 lists two reports, namely C & D, and report batch file 32 lists two reports, namely A & B. Report parsing process 42 generates a report master list 46 that itemizes all the individual reports to be generated for all the selected report batch files, e.g., and 32 in this example. In this particular example, report master list 46 includes reports A, B, C & D, as batch report file 30 includes reports C & D and batch report file 32 includes reports A & B. Redundancies would not be included on master list 46 generated by report parsing process 42. A status indicator is included for each report listed on report master list so that the status of each report can be monitored. This status indicator will be explained below in greater detail.

A redundancy filtering process 48 checks all entries on report master list 46 to determine if any reports are listed more than once and, accordingly, removes such redundant entries. For example, if report batch file 32 included a third report, namely C, redundancy filtering process 48 would remove the second occurrence of report C from report master list and, therefore, report master list 46 would list report C only once. Please note that for illustrative purposes, reports having like designations (i.e. A, B, C, etc.) are considered to be identical reports. Therefore, for this example, if there are any differences between these reports, the reports would have different report designations assigned to them.

When report parsing process 42 generates report master list 46 which lists all the reports that are to be generated for all selected report batch files 24₁₋ₙ, report master list 46 also includes the required ownership and routing information so that the reports (namely A, B, C & D) specified in report master list 46 can be properly routed (using either an email address, an IP address, etc.) to the user that requested them. As stated above, all redundant entries (i.e. reports) are removed from report master list 46. Therefore, if redundant entries are removed, a single report listed on report master list 46 will have to be routed to more than one user.

A report generation process 50 is responsive to report parsing process 42 generating report master list 46. This report generation process 50 is the subject of U.S. patent application Ser. No. 09/191,655, entitled “Report Generation Architecture for Remotely Generated Data”, filed on Nov. 13, 1998, and incorporated herein by reference. Report generation process 50 generates all individual reports 52 contained in report master list 46. These reports 52 are generated from data (not shown) available from data services process 22. Typically this data is market data which concerns various companies traded on an electronic market such as the Nasdaq™ Stock Market. This data is typically stored on data repository 38. Once generated, reports 52 are made available to user 26. These reports can be either: transmitted to user 26 as an email message attachment; retrieved and download by user 26 from a remote website; or viewed online by user 26. In this particular example, if user 26 was the owner (and therefore the scheduler) of report batch files 30 and 32, user 26 would retrieve reports 12 via network 16 and desktop computer 20, where reports 12 retrieved by user 26 would be individual reports A, B, C & D.

Alternatively, if user 26 only owned report batch file 30 and second user 54 owned report batch file 32, user 26 would only retrieve individual reports C & D and user 54 would only retrieve individual reports A & B. Accordingly, the ownership and routing information incorporated into report master list 46 would specify that reports A & B were owned by user and that reports C & D were owned by user 26, where access to the specific reports would only be granted to the user who scheduled and requested them.

Report posting process 56 posts individual reports 52 generated by report generation process 50 to server 14 on distributed computing network 16 so that reports 12 ordered and scheduled by user 26 can be retrieved by from generated reports 52. Typically, these reports would be posted to an Internet-accessible web site, where the reports can be retrieved and/or viewed by user 26 via a standard web browser (e.g. Netscape™, Internet Explorer™, and so forth). As stated above, since reports C & D are owned by user 26 and reports A & B are owned by user 54, these reports can only be accessed (and downloaded) by their respective owner. These reports are posted in groups which correspond to the specific report batch file 24₁₋ₙ (or folio) ordered by the user. Therefore, report group 58 (reports A & B) can only be accessed and downloaded by user 54. Further, report group 60 (report C & D) can only be accessed and downloaded by user 26.

A report transmission process 62, which is responsive to report generation process 50 generating reports 52, transmits these reports to the user who ordered them via network 16. Typically, these reports are sent to their respective users as electronic mail attachments. As with report posting process 56, the reports transmitted to the individual users via report transmission process 62 are only those reports ordered by that specific user. Accordingly, report group 58 would be transmitted to user 54 and report group 60 would be transmitted to user 26.

As reports 52 generated by process 10 typically report various stock conditions, it is highly desirable to delay report generation until after trading for that day has closed, or generally until late night/early morning when the load on server 14 that runs process 10 is low and network traffic is reduced. Therefore, master delay process 64 can delay the generation of all the individual reports 52 generated by report generation process 50 until after a specific time. Typically, the decision to delay the generation of reports 52 via master delay process 64 is an administrative decision. Therefore, the person administering process 10, as opposed to the user using process 10, typically decides what time the reports are generated.

Some reports require information that must be manually verified prior to the generation of the report, such as a trade history report for the previous month that is scheduled for monthly delivery. This manual verification process is referred to as reconciliation. Report generation delay process 74 can delay the generation of any specific individual report listed on report master list 46 until after the occurrence of the manual reconciliation process. This enables the generation of reports that include information that would not otherwise be available until after the occurrence of the reconciliation event.

In addition to storing and serving the group of report batch file 24₁₋ₙ, data repository 38, which is accessed via data services process 22, typically also stores stock market related data 66 (e.g. stock prices, hi prices, low price, volume information, index prices, etc.). When a stock market closes, various pieces of information are available that will have to be reset prior to the opening of the market on the next trading day. Examples of this “time sensitive” information are: a particular stock's trading volume; high price; low price; market trading volume; and so forth. As would be expected, if a report is desired that requires any time sensitive information, that information must be retrieved prior to system replication (the process of resetting the system for the next trading day, which results in the loss of all time sensitive data).

Data retrieval process 68 retrieves time sensitive data 70 (which is a member of stock market related data 66 stored on data repository 38) from data services process 22 prior to the occurrence of a replication event which, as stated above, resets a stock market trading system for the next trading day's business. Time sensitive data 70 is made available to report generation process 50 when the particular report requiring the time sensitive data is generated. An example of a report that includes time sensitive data is a quickview last sale report.

Batch file schedule process 40 includes batch file filtering process 72 which examines the content of each report batch file 24₁₋ₙ to determine if its respective list of reports specifies at least one individual report for generation by report generation process 50. Batch file filtering process 72 improves server efficiency by preventing the processing of any report batch files which do not specify a single report for generation.

Report status process 76 is responsive to report parsing process 42 generating report master list 46 and providing list 46 to report generation process 50. Report status process 76 assigns a status indicator to each report itemized on report master list 46 and monitors the generation of these reports by report generation process 50. Typical examples of these status indicators would be: a “1” for a report that is to be generated immediately; a “2” for a report that is in the process of being generated; a “3” for a report that has been generated; a “9” for a report that is to be delayed until the occurrence of a certain event (e.g. reconciliation) or until after a certain time, and so forth. Therefore, in the event that report generation delay process 74 delays the generation of a specific report, report status process 76 would assign a status indicator of “9” to that report, which would result in the generation of that report being delayed until a later time (typically, after the occurrence of a reconciliation event). Once this event has occurred, that report's status indicator would be toggled from a “9” (delay processing) to a “1” (immediate processing) and that individual report would be generated by report generation process 50. Further, if master delay process 64 was delaying the generation of all reports until a later time, report status process 76 would assign a “9” to all reports. Once the scheduled delay time has passed, the status indicator associated with all the delayed reports would be toggled from a “9” to a “1”. Accordingly, report generation process 50 will only process reports having a status indicator of “1”. When these reports are being processed by report generation process 50, report status process 76 will change that report's status indicator from a “1” (process immediately) to a “2” (being processed). Finally, once generation of that specific report is completed by report generation process 50, report status process 76 will change that report's status indicator from a “2” (being processed) to a “3” (processing complete).

User interface process 78 allows user 26 to manage the report batch file(s) owned by that user. Adding to the example stated above, user 26 is the owner of report batch file 32 which includes individual reports A & B and is scheduled to be run daily. In the event that user 26 wanted to add an additional report L to that list, user interface process 78 would allow user 26 to make the required changes. Further, if user 26 wanted to change the periodicity of this scheduled report generation (currently set for daily generation), user interface process 78 would allow user 26 to accomplish this. User interface process 78 can be a stand-alone application that resides on desktop computer 20 or it can be an application that resides on server 14 that the user 26 accesses through desktop computer 20 via a web browser (not shown).

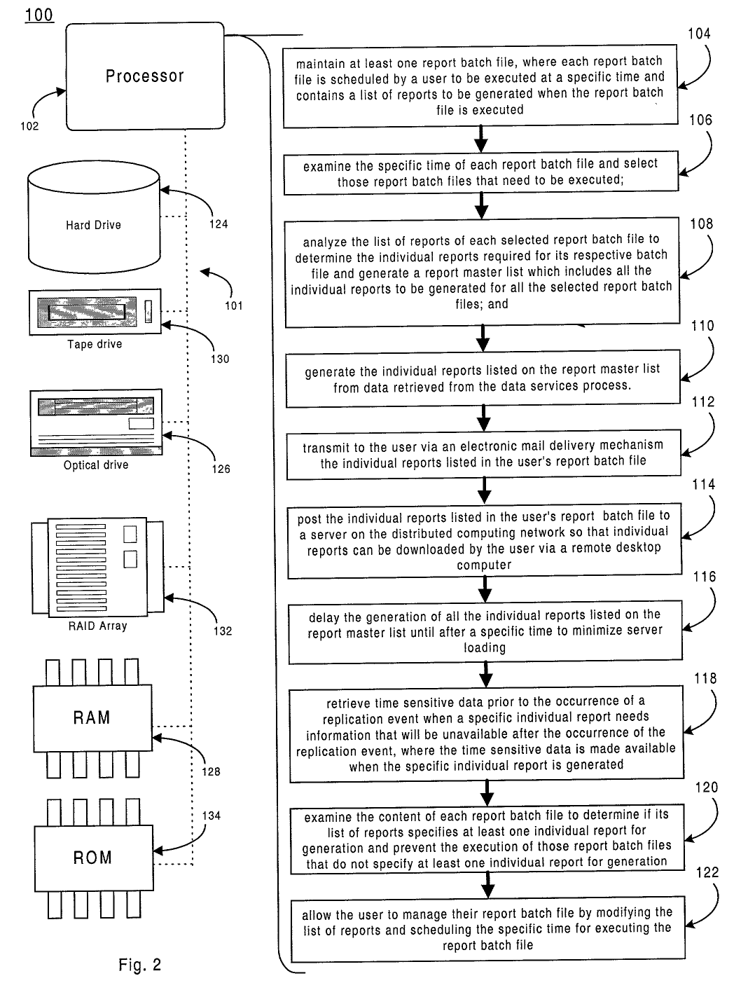

Referring to FIG. 2, there is shown a computer program product 100 residing on a computer readable medium 101 having instructions stored thereon which, when executed by processor 102, cause that processor to maintain 104 at least one report batch file. Each report batch file is scheduled by a user to be executed at a specific time and contains a list of reports to be generated when the report batch file is executed. Processor 102 examines 106 the specific time of each report batch file and selects those report batch files that need to be executed. An analysis 108 is made of the list of reports of each selected report batch file to determine the individual reports required for its respective batch file. A report master list is generated. The report master list includes all the individual reports to be generated for all the selected report batch files. Finally, processor 102 generates 110 the individual reports listed on the report master list from data retrieved from a data services process.

Processor 102 transmits 112 to the user, via an electronic mail delivery mechanism, the individual reports listed in the user's report batch file. The individual reports listed in the user's report batch file are posted 114 to a server on a distributed computing network so that the individual reports can be downloaded by the user via a remote desktop computer. To minimize server loading, processor 102 can delay 116 the generation of all of the individual reports listed on the report master list until after a specific time. In the event of time sensitive data being required, processor 102 can retrieve 118 time sensitive data prior to the occurrence of a replication event when a specific individual report needs information that will be unavailable after the occurrence of the replication event, where the time sensitive data is made available when the specific individual report is generated. Processor 102 examines 120 the content of each report batch file to determine if its list of reports specifies at least one individual report for generation and prevents the execution of those report batch files that do not specify at least one individual report for generation. Finally, processor 102 allows 122 the user to manage their report batch file by modifying the list of reports and scheduling the specific time for executing the report batch file.

Typical embodiments of computer readable medium 101 are: hard drive 124; optical drive 126; random access memory 128; tape drive 130; RAID array 132; and read only memory 134.

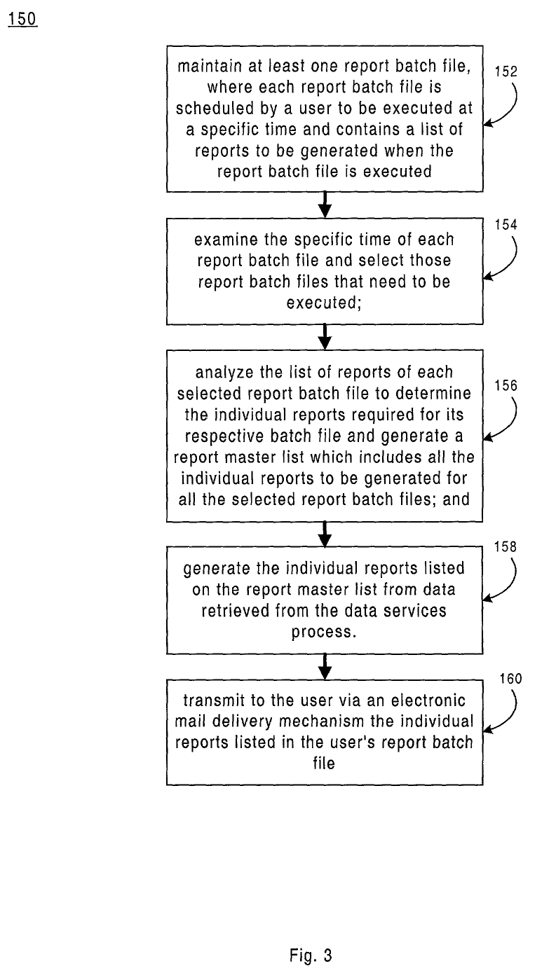

Referring to FIG. 3, there is shown a method 150 for scheduling the generation of reports including maintaining 152 at least one report batch file, where each report batch file is scheduled by a user to be executed at a specific time and contains a list of reports to be generated when the report batch file is executed. Method 150 examines 154 the specific time of each report batch file and selects those report batch files that need to be executed. An analysis 156 is made of the list of reports of each selected report batch file to determine the individual reports required for its respective batch file. Method 150 generates 156 a report master list, which includes all the individual reports to be generated for all the selected report batch files. Method 150 generates 158 the individual reports listed on the report master list from data retrieved from a data services process. Finally, method 150 transmits 160 to the user, via an electronic mail delivery mechanism, the individual reports listed in the user's report batch file.

Other embodiments are within the scope of the following claims.

What is claimed is:

1. A process, residing on a server, for scheduling the generation of reports, for retrieval via a distributed computing network by a desktop application program residing on a remote desktop computer comprising:
a data services process that maintains at least one report batch file, where each said report batch file is scheduled by a user to be executed at a specific time and contains a list of reports to be generated when said report batch file is executed.

2. The process of claim 1 further comprising:
a batch file schedule process that examines said specific time of each said report batch file and selects those said report batch files that need to be executed.

3. The process of claim 2 further comprising:
a report parsing process, responsive to said batch file schedule process selecting report batch files for execution, for analyzing said list of reports of each said selected report batch file to determine the individual reports required for its respective batch file and for generating a report master list of all individual reports to be generated for the selected report batch files.

4. The process of claim 3 further comprising:
a report generation process, responsive to said report parsing process for generating said individual reports listed on said report master list from data retrieved from said data services process, said individual reports being made available to the user.

5. The process of claim 4 further comprising:
a report posting process which posts individual reports generated by said report generation process to a server on the distributed computing network so that said reports can be downloaded by the user via a remote desktop computer.

6. The process of claim 4 including a report transmission process, responsive to said report generation process generating said individual reports, for transmitting to the user via an electronic mail delivery mechanism said individual reports listed in the respective user's report batch file.

7. The process of claim 4 including a master delay process that delays the generation of all said individual reports listed on said report master list until after a specific time to minimize server loading.

8. The process of claim 4 wherein said report parsing process includes a report generation delay process that delays the generation of a specific individual report listed on said report master list until after the occurrence of a reconciliation event when said specific individual report needs information that will not be available until after the occurrence of said reconciliation event.

9. The process of claim 4 including a data retrieval process that retrieves time sensitive data from said data services process prior to the occurrence of a replication event when a specific individual report needs information that will be unavailable after the occurrence of said replication event, where said time sensitive data is made available to said report generation process when said specific individual report is generated.

10. The process of claim 4 wherein said batch file schedule process includes a batch file filtering process that examines the content of each said report batch file to determine if its list of reports specifies at least one individual report for generation by said report generation process, where said batch file schedule process prevents the execution of those report batch files that do not specify at least one individual report for generation.

11. The process of claim 4 including a report status process, responsive to said report parsing system generating said report master list, that associates a status indicator with each said individual report listed on said report master list which indicates the status of the generation of that specific individual report.

12. The process of claim 4 including a user interface process that allows the user to manage their report batch file by modifying said list of reports and scheduling said specific time for executing said report batch file.

13. A process, residing on a server, for scheduling the generation of reports, for retrieval via a distributed computing network by a desktop application program residing on a remote desktop computer comprising:
a data services process that maintains at least one report batch file, where each said report batch file is scheduled by a user to be executed at a specific time and contains a list of reports to be generated when said report batch file is executed;
a batch file schedule process that examines said specific time of each said report batch file and selects those said report batch files that need to be executed;
a report parsing process, responsive to said batch file schedule process selecting report batch files for execution, that analyzes said list of reports of each said selected report batch file to determine the individual reports required for its related batch file and generates a report master list which includes all said individual reports to be generated for all said selected report batch files;
a report generation process, responsive to said report parsing process generating said report master list, that generates said individual reports listed on said report master list from data retrieved from said data services process; and
a report transmission process, responsive to said report generation process generating said individual reports, for transmitting to the user via an electronic mail delivery mechanism said individual reports listed in said user's report batch file.

14. The process of claim 13 including a report posting process which posts said individual reports generated by said report generation process to a server on the distributed computing network so that said reports can be downloaded by the user via a remote desktop computer.

15. A computer program product residing on a computer readable medium having a plurality of instructions stored thereon which, when executed by the processor, cause that processor to:
maintain at least one report batch file, where each report batch file is scheduled by a user to be executed at a specific time and contains a list of reports to be generated when the report batch file is executed;
examine the specific time of each report batch file and select those report batch files that need to be executed;
analyze the list of reports of each selected report batch file to determine the individual reports required for its respective batch file and generate a report master list which includes all the individual reports to be generated for all the selected report batch files; and
generate the individual reports listed on the report master list from data retrieved from the data services process.

16. The computer program product of claim 15 further comprising instructions for causing the processor to transmit to the user via an electronic mail delivery mechanism the individual reports listed in the user's report batch file.

17. The computer program product of claim 15 further comprising instructions for causing the processor to post the individual reports listed in the user's report batch file to a server on the distributed computing network so that individual reports can be downloaded by the user via a remote desktop computer.

18. The computer program product of claim 15 further comprising instructions for causing the processor to delay the generation of all the individual reports listed on the report master list until after a specific time to minimize server loading.

19. The computer program product of claim 15 further comprising instructions for causing the processor to retrieve time sensitive data prior to the occurrence of a replication event when a specific individual report needs information that will be unavailable after the occurrence of the replication event, where the time sensitive data is made available when the specific individual report is generated.

20. The computer program product of claim 15 further comprising instructions for causing the processor to examine the content of each report batch file to determine if its list of reports specifies at least one individual report for generation and prevent the execution of those report batch files that do not specify at least one individual report for generation.

21. The computer program product of claim 15 further comprising instructions for causing the processor to allow the user to manage their report batch file by modifying the list of reports and scheduling the specific time for executing the report batch file.

22. A method for scheduling the generation of reports comprising:
maintaining at least one report batch file, where each report batch file is scheduled by a user to be executed at a specific time and contains a list of reports to be generated when the report batch file is executed;
examining the specific time of each report batch file and selecting those report batch files that need to be executed;
analyzing the list of reports of each selected report batch file to determine the individual reports required for its respective batch file and generating a report master list which includes all the individual reports to be generated for all the selected report batch files; and
generating the individual reports listed on the report master list from data retrieved from the data services process.

23. The method of claim 22 further including transmitting to the user via an electronic mail delivery mechanism the individual reports listed in the user's report batch file.
